(19) United States
(12) Patent Application Publication
(10) Pub. No.: US 2018/0121844 A1
(43) Pub. Date: May 3, 2018

(54) SYSTEM FOR TESTING AND SCORING COMPUTER SYSTEMS AGAINST OBJECTIVE STANDARDS

(71) Applicant: Corsis LLC, New York, NY (US)

(72) Inventors: GREGG ALWINE, New York, NY (US); David Barnett, New York, NY (US); Leonard Herold, New York, NY (US); Bradley Karst, New York, NY (US); Laura Krassner, New York, NY (US); Thomas Shelford, New York, NY (US); David Stricker, New York, NY (US); Robert Sullivan, New York, NY (US)

(21) Appl. No.: 15/336,434

(22) Filed: Oct. 27, 2016

(51) Int. Cl. G06Q 10/06; G06F 21/57; G06N 99/00

(52) U.S. Cl. CPC G06Q 10/0635; G06Q 10/06393; G06F 2221/033; G06N 99/005; G06F 21/577

(57) ABSTRACT

The system receives one or more technical standards and compared the operations of an entity to the standards. The comparison may score the entity in comparison to each of the technical standards and may create a compositing rating based on all the standards. The comparison may be based on static code sections or may be based on real time analysis of code sections that are live. Further, if the ratings are below a threshold, the system may recommend changes to increase the rating to be above the threshold.

### BACKGROUND

Computer systems have risks. The risks range from personally identifiable information and valuable business data being stolen, to violation of government regulations and even lost revenue and business asset value. Logically, businesses and individuals would like to take steps to avoid such risks. However, with the ever changing technological landscape, keeping up with known and unknown risks is extremely difficult. Further, addressing one risk may expose the business or entity to yet another attack related to another risk. Finally, there are a variety of opinions of what risks have the greatest importance and which risks have the lowest importance.

In addition, addressing all risks may make it impossible to make use of a computer system, to have an online presence, or to operate the business, as addressing all risks would be virtually impossible and extremely expensive. At the same time, successfully operating a business by making use of the computer system and/or having an online presence is of great importance. It would be useful to compare the level of risk of one entity in comparison to similar entities such that the entity may have an idea of how they compare to their peers.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

The claimed computer system determines a confidence level for technological operations meeting an objective plurality of standards for an entity. The system receives one or more technical standards and compares the operations of an entity to the standards. The standards may be many and varied depending on the entity, and the entity's business, industry or area of focus. The comparison may score the entity in comparison to each of the technical standards and may create a composite rating based on all the standards. The comparison may be based on static code sections or may be based on real time analysis of code sections that are live.

Further, if the ratings are below a threshold, the system may recommend changes to increase the rating to be above the threshold. Related, the system may store entity classifications and ratings or scores and may compare a first entity to other entities in the similar entry classification. The ratings or scores may be provided to the entities such that they may determine if they are on par with other entities of a similar size or similar business. Further, an entity's ratings or scores may be revisited and re-measured over time to identify substantive changes or for other benchmarking purposes.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the hardware used in the system;

FIG. 2 is a flowchart of blocks executed by the processor;

FIG. 3 is an illustration of a graphical user interface illustrating an analysis by the system;

FIG. 4 is an illustration of a graphical user interface illustrating an analysis by the system including additional information by selecting an element;

FIG. 5 is an illustration of a graphical user interface illustrating a summary of the analysis by the system; and

FIG. 6 is an illustration of a machine learning system that may be used as part of the system.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SPECIFICATION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

At a high level, it is known that computer systems have risks. The risks range from personally identifiable information and being stolen to valuable business data being stolen, to violation of government regulations, data loss, corruption of files, lack of scale, performance failure, etc., which could lead to lost revenue and business asset value. Logically, businesses and individuals would like to take steps to avoid such risks. However, with the ever changing technological and regulatory landscape, keeping up with known and unknown risks is extremely difficult. Further, addressing one risk may expose the business or entity to yet another open up an attack related to on another risk. Finally, there are a variety of opinions of what risks have the greatest importance and which risks have the lowest importance or how to remediate such risks that may exist.

In addition, addressing all risks may make it challenging to make use of a computer system, to have an online presence, or to operate the business, as addressing all risks would be very challenging and extremely expensive. At the same time, successfully operating a business by making use of the computer system and/or having an online presence is of great importance. It would be useful to compare the level of risk of one entity in comparison to similar entities such that the entity may have an idea of how they compare to their peers.

In response, the claimed computer system may determine a confidence level for technological operations meeting an objective plurality of standards, which may be required or desired by an industry, customer, or the entity itself. The system receives one or more technical standards and compared the operations of an entity to the standards. The standards may be many and varied depending on the entity. The comparison may score or rate the entity in comparison to each of the technical standards and may create a compositing rating based on all the standards. The comparison may be based on static code sections or may be based on real time analysis of code sections that are live.

Further, if the ratings are below a threshold, the system may recommend changes to increase the rating to be above the threshold. Related, the system may store entity classifications and ratings and may compare a first entity to other entities in the similar entry classification. The ratings may be provided to the entity such that it may be determined if they are on par with other entities of a similar size or similar business.

Computer learning may be used as part of the system. As more and more entities are analyzed, the data from previous systems may be analyzed to create a model that better predicts future aspects of the model. The learning aspect of the system may be used to set thresholds, identify elements to be analyzed, identify weights to be added to elements to be reviewed, identify rules to be used on data, etc. As a result, the system may continually improve and take into account changing issues that may be addressed.

Computer System

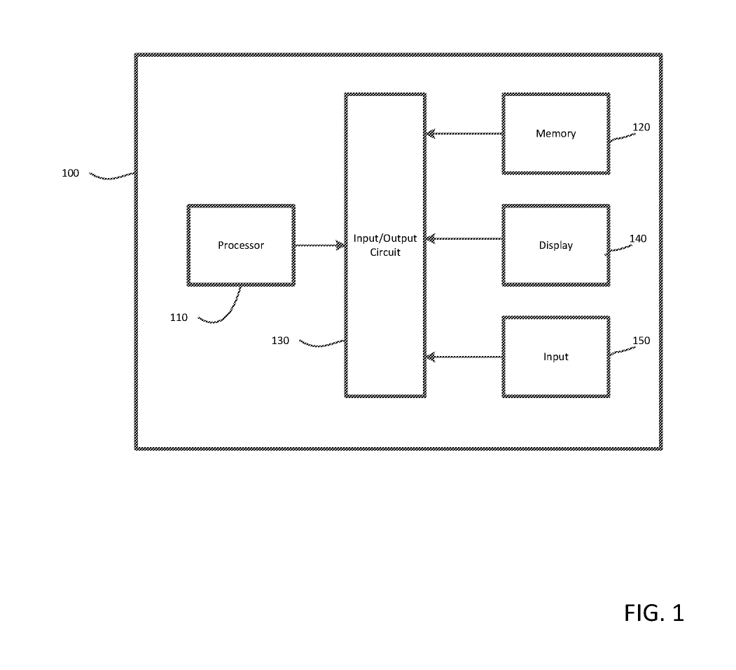

Referring to FIG. 1, a computer system 100 for determining a confidence level for technological operations meeting an objective plurality of standards for an entity may be illustrated. The computer system 100 may include a processor 110 which is physically configured to be make the necessary determinations. In some embodiments, the processor 110 is purpose built to make the necessary determinations. In other embodiments, the processor 110 is physically configured according to computer executable instructions for the necessary determinations.

The computer system also may have a memory 120 that stores computer executable instructions. The memory 120 may also be used to support the processor by storing instructions waiting to be executed by the processor. Further, the memory 120 may store instructions to be executed by other elements of the system 100. The memory may be volatile or non-volatile and may take a variety of forms such as a memory chip, a magnetic hard drive, a solid state drive, etc.

The computer system 100 may also include an input output circuit 130 in communication with the processor 110. The input output circuit 130 may control instructions to additional elements that are in communication with the system 100 such as a display 140, an input device 150, etc. The input output circuit 130 may control how data proceeds to and from the processor and in what order.

The computer executable instructions may be written in any appropriate computer language such as Java, Ruby, Ruby on Rails, C, C++, C#, Python, assembler, etc., or a combination thereof. For example, some applications or procedures may be written in one language and other applications may be written in another language. As long as each application knows what data to expect to be received and what to be sent, the applications should be able to operate together.

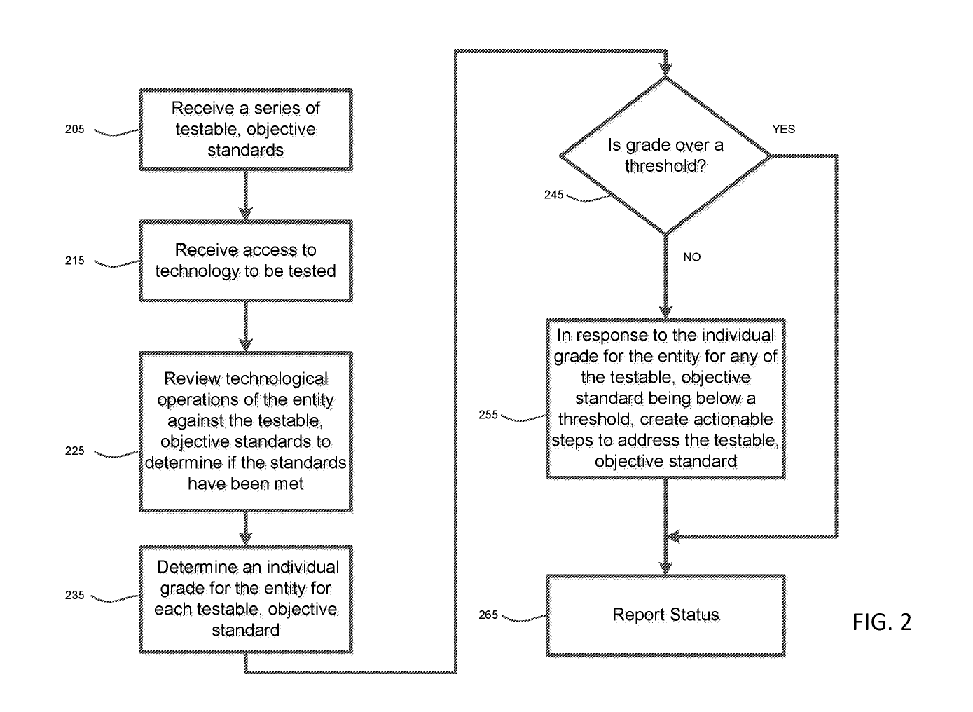

The computer instructions may be broken down into blocks and the blocks may represent functions or determinations to be executed by the processor. The blocks may be illustrated in FIG. 2. The block may be in a single or a variety of applications, programs or processors which may call and pass data to each other.

Referring to FIG. 2, at block 205, a series of testable, objective standards may be received. The standards may be of a variety of standards. The purpose of the standards may be to test or determine whether an entity has met a minimum threshold of an aspect of its operations. As an example, HIPAA regulations may require that data related to a patient be kept private and only be disclosed under certain circumstances. The standard may define what is patient data and may define the circumstances that may permit the data to be disclosed to certain individuals.

As another example, the standard may be related to computer security. A variety of tests may be created to ensure a website or network access is secure from unwanted intruders. Logically, there may be a variety of ways to access a network. A variety of the most logical approaches to access a network may be tested against the standard of not allowing unauthorized access to the network. In yet another embodiment, the standards may be for software applications used by the entity and the standard may require a license for each software application used by the entity. If a software application does not have a license, the standard may not be met. Similarly, the standard may be related to a “keyman” or a single person that has access or control to parts of a network wherein the keyman could single handedly shut down the network.

Machine Learning

In some embodiments, the factors that affect the risk of violating a standard may be determined through neural network type machine learning. In a machine learning type of environment, a set of training data or knowledge data is broken into groups. A first group is set aside and the other sets of data are used as training data to create a model of how the data performs. The first set of data is used to test the model. Next, the data sets rotate, where the first set of data is added to the training data and one set of the previous training data is used as test data. The rotation process may repeat until all the data sets have been used as test data. Eventually, a model of the data will emerge. The model may be used to further enhance the standards that are reviewed and what may indicate that complying with a standard is at risk.

As a simple example, five elements (elements 1-5) may be reviewed as they relate to how at risk a network may be to an unwanted intrusion. A significant number of previous networks may have been studied and the networks may be broken into four groups (groups 1-4). The first three groups (groups 1-3) may be used to train the model and the fourth group (group 4) may be used as a testing group. The first three groups may be used to weight the five elements as they relate to an unwanted intrusion. Then the fourth group may use the model and the predicted risk of intrusion may be compared to the actual results of intrusion on the fourth group. Then the groups may rotate and the model may be tweaked by using the first group as the testing group and adding group 4 to the training group. And the model may continue to rotate through all the groups until each of the four groups has been used as a testing group. The various elements may be given weights and the weights may be adjusted based on the analysis to better predict the results in the testing group. The model may then continually improve as more data is added to the system.

In addition, the system may be used to predict risks and over time, the predictions may be compared to actual results to improve the model. Using the previous model, data from a fifth group may be subjected to the model and a predicted risk of unwanted intrusion may be received. On a periodic basis, the actual results (whether there has been an unwanted intrusion) may be compared to the predicted results of an unwanted intrusion. The results may be used as feedback to continually improve the model. Of course, additional factors may be added to better improve the predictability of the model.

Standard Requirements

While the standards may be many and varied, there may be some requirements for the standard. In one aspect, the standard may be testable such that a determination may be made whether the standard has been met. For example, if the standard is that a network “must be stable” there is not a way to easily test or determine whether a network is stable. What is stable to one person may not mean the same thing to another person. In the alternative, a standard that a network have at least 99% uptime may be testable by reviewing past network logs.

Similarly, the standards may be objective such that determinations will not be disputed and will be consistent across entities. As noted earlier, a standard may be that a network have an uptime of at least 99% percent which is objective as it may be determined using standard scientific techniques. In addition, the manner in which the objective standard is met may also be subject to a standard. However, if the standard was that the network “must be stable”, there may be a wide range of opinions of what users consider stable and what professionals consider as stable and how the network was made stable. By creating objective standards as in the described system, the likelihood of disputes regarding whether a standard has been met may be reduced.

Further, the standards may be applied consistently across a desired group such that results of the standards determination may be compared across the group. For example, the standard uptime percentage for a network should be similar across a group of similar entities. For example, a group of online merchants may desire to compare uptime for their networks to determine if they are within range of their competitors.

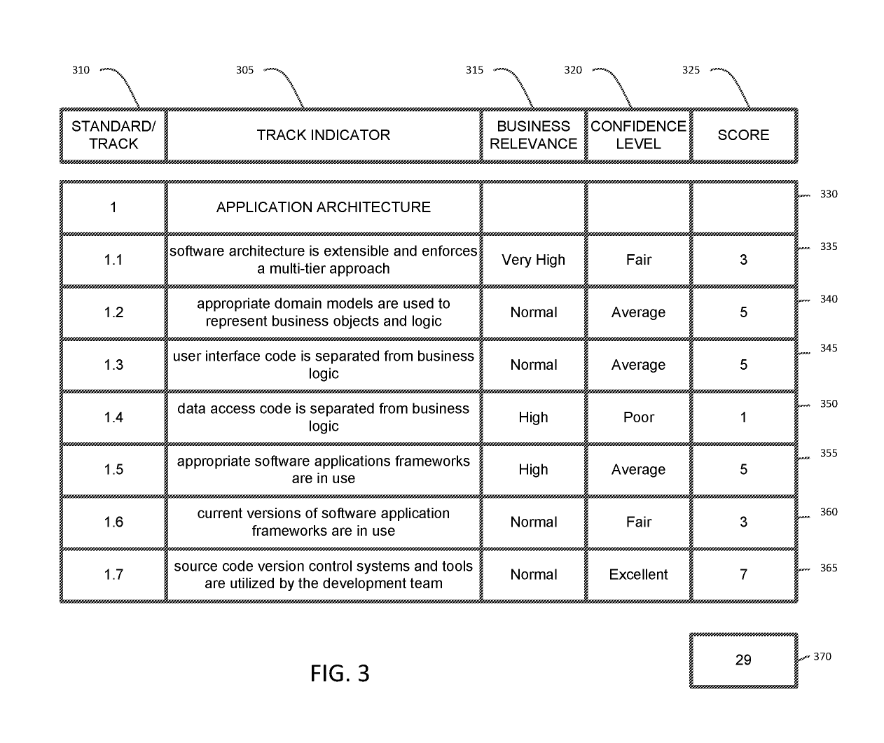

The standards may be broken down into elements 310 or categories. For example, as illustrated in FIG. 3, Application Architecture 330 may be a standard that is reviewed. Under Application Architecture, there may be several elements or indicators 305 of the standards 330 such as:
software architecture is extensible and enforces a multi-tier approach 335;
appropriate domain models are used to represent business objects and logic 340;
user interface code is separated from business logic 345;
data access code is separated from business logic 350;
appropriate software applications frameworks are in use 355;
current versions of software application frameworks are in use 360; and
source code version control systems and tools are utilized by the development team 365.

Similar standards 330 may be in place for a variety of additional aspects of the computing use of an entity. The standards categories 335-365 also may indicate the “Business Relevance” 315, the “Confidence Level” 320, and a score 325 or rating. The Business Relevance 315 may be a rating of how the standard 330 may affect the business operations as generally understood to be true or as defined by a client, an investor, an administrator, etc. The Confidence level 320 may indicate how well the system 100 was able to review the elements 335-365 of the standard 330. The score or grade 325 may be a number or other alphabetic, numeric, or graphical representation used to reflect overall performance in view of the elements 336-365 of a standard 330. An overall score 370 may reflect the overall ability of the entity to meet the threshold of the elements of a standard 330 as refined by the business relevance.

Referring again to FIG. 2, at block 215, access to the technological equipment or instructions may be received. If the equipment is hardware, actual physical analysis may be required. If the equipment is software or network access, administrative rights to access and review the computer executable instructions may be made available.

At block 225, technological operations of the entity may be reviewed against the testable, objective standards to determine if the standards have been met. In some embodiments, the standard may have a variety of levels and the appropriate level may be determined. In some embodiments, each standard in a category may be reviewed and it may be determined if each standard in a category has been met.

At block 235, the system 100 may determine an individual grade for the entity for each testable, objective standard based on the evaluation such that areas which need to be improved and areas which are operating effectively are highlighted. There may be varying levels of meeting a standard. In some situations, a standard may be met with a minimum arrangement of equipment. In other situations, a standard may be met to face current and future threats with great certainty. The level of meeting the standard may be given a grade or score.

In some embodiments, the standards may be broken down into categories. The grades in individual categories in the standard may be aggregated to determine an overall value for a standard. The aggregation may occur in a variety of ways. In some embodiments, the aggregation may be a simple averaging of the individual standard. In other embodiments, some standards may be given a heavier weight than other standards. The grades may take on a variety of forms. In some embodiments, the grade may be a number such as a number between 0-100.

At block 245, the grade may be compared to a threshold. The threshold may be set to reflect a number of inputs, including regulatory requirements, industry best practices, the entity's own determination of business relevance, or other factors, and the system may indicate whether the standard has been graded to be above or below the threshold. In another embodiment, the grade may be simple pass/fail type grades.

The threshold may be set in a variety of ways depending on the industry, the importance, the sophistication of the client, etc. For example, the level of security for a health care provider may be higher than the security for a personal web site. Thus, the threshold may be set lower when reviewing personal web sites than when reviewing web sites for health care providers.

The threshold also may adjusted automatically through feedback to a machine learning application such that the threshold may better match what is occurring in a particular group or within a particular industry. As an example, if the entities in an industry have a high score for security, the threshold for security in that industry may be raised above that of other industries. Similarly, if the entities in an industry have a low score for security, the threshold for security in that industry may be lowered below that of other industries. Logically, the learning algorithm may see trends such as security scores in a group raising and may raise the threshold for the industry automatically.

Similar to the arrangement related to the elements of the standard, determining a threshold may involve machine learning. Past experiences with thresholds may be used determine future threshold based on a number of elements. The various elements also may vary and may be determined by improving the system over time, using the model to predict the future and comparing the predictions to the actual outcome.

At block 255, in response to the individual grade for the entity for any of the testable, objective standard being below a threshold, actionable steps to address the testable, objective standard may be created. Logically, when a problem is found a solution may be offered. The solution may take on a variety of forms depending on the problem that has been identified. In one embodiment, the system 100 may recommend one or more vendors that are skilled at addressing the problem. In other embodiments, the system 100 may estimate the costs of the recommendations. The recommendation may be based on previous fixes for similar customers or from estimates from vendors.

The determinations may be presented in a variety of ways. In one embodiment, an overall score may be given by the system. The grade may be a simple average or may be a weighted average of the grades of the various standards. The grades may be a number, a color, a sign, a symbol, etc.

In another embodiment, the determination may be a ranking. For example, an entity may wish to stay in the top 25% of an industry. The system 100 may receive an industry classification for the entity, may determine similar entities based on an algorithm, may compare the rating for the entity to the determined similar entities and may determine a ranking the entity in view of the determined similar entities. In such a situation, if the ranking is below a threshold, a list of recommended improvements may be created to move above the threshold.

In response to the grade being determined to be under a threshold, a variety of steps may be taken in order that the failed standard may be addressed. In one embodiment, a hierarchical list of actionable steps may be created to address each of the testable, objective standards that were not met. The hierarchy may be determined in a variety of ways. In one embodiment, the most logical solution to meet the standard may be the first in the hierarchy. In another embodiments, solutions which may be implemented without additional hardware may be listed higher in the hierarchy. Of course, the hierarchy may be tailored to an entity, an entity customer, an industry, a geographic area, etc.

The actionable steps may be known in advance or may be created according to a sequence of decisions. For example, a failure of a standard may only have one cause and the actionable steps may be addressed to that one cause. In another situation, a failure of a standard may have a variety of causes and a series of determinations may be needed to determine the most likely cause from the least likely cause. In some embodiments, additional tests may be performed to assist in determining if one cause of failing the standard is more likely than another cause. The more likely causes may be higher in the hierarchy than less likely causes.

In addition, machine learning may be used to determine the actionable steps that are most likely to meet a standard. For example, a series of past approaches to meeting a standard may be analyzed along with other elements such as the elements of the type of organization, the type of standard, the type of technology, etc. By using machine learning, the hierarchy of approaches to address a standard may be improved.

At block 265, the status of the entity in relation to the standards may be reported. FIG. 3 may be a sample report. The report may have several sections where each section covers an area of review of one or more standards. Each area of review may have subsections. As mentioned previously, as an example, the standards may be broken down into categories. For example, as illustrated in FIG. 3, Application Architecture may be reviewed. Under Application Architecture, there may be several standards such as:
software architecture is extensible and enforces a multi-tier approach
software architecture is extensible and enforces a multi-tier approach 335;
appropriate domain models are used to represent business objects and logic 340;
user interface code is separated from business logic 345;
data access code is separated from business logic 350;
appropriate software applications frameworks are in use 355;
current versions of software application frameworks are in use 360; and
source code version control systems and tools are utilized by the development team 365.

Similar standards may be in place for a variety of additional aspects of the computing use of an entity.

The categories also may indicate the “Business Relevance”, the “Confidence Level”, and a score or rating. The Business Relevance 315 may be a rating of how the standard 330 may affect the business operations. The Confidence level 320 may indicate how well the system 100 was able to review the elements 335-365 of the standard 330.

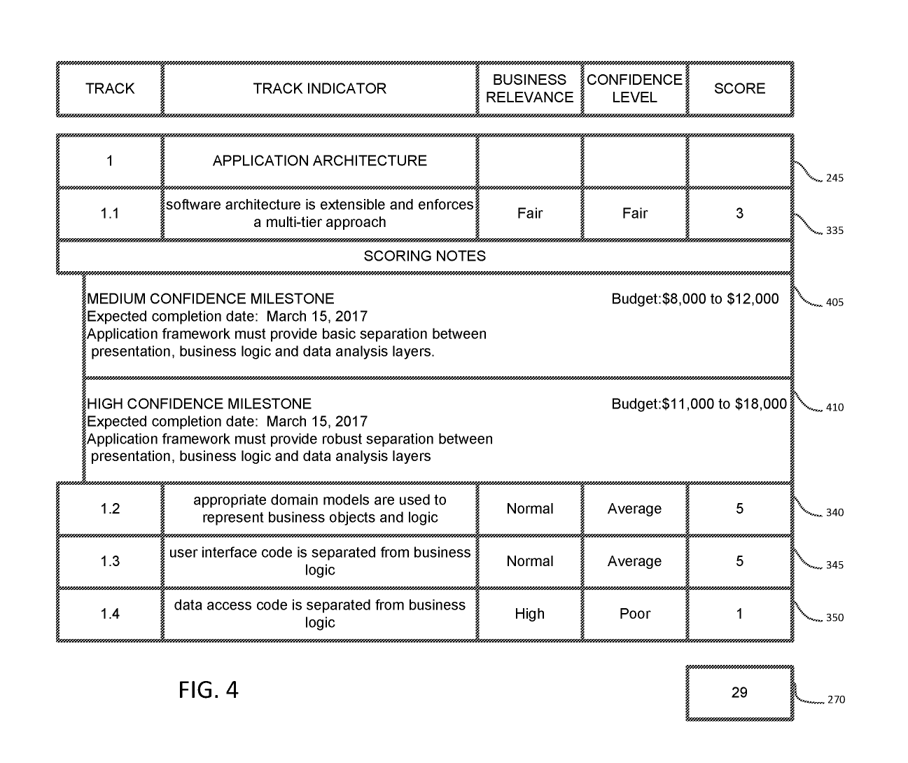

Each standard may be selected for additional information. For example, referring to FIG. 4, additional information on standard 1.1 335 may be received by selecting it. An additional graphical element may appear which may add additional details 405-410 about element 1.1, how the elements were scored and what the cost may be to improve from one ratings group to another such as from Medium to High.

The analysis may occur in a variety of ways. In one embodiment, if the analysis is of computer instructions, the computer instructions may be loaded into a data room where the instructions may be accessed and analyzed. In another embodiment, the analysis tool may be on the system to be analyzed and the analysis tool may operate periodically to grade the system against the relevant standards. In yet another embodiment, the analysis tool may operate in real time and may offer a continuous rating of system and may immediately notify an administrator if a standard has not been met.

In another aspect, a proposed cost to meet the standard also may be displayed 405-410. The proposed cost may be determined from pre-set estimates. In another embodiment, the costs may be determined from reviewing previous costs to address the similar standard in the past for other entities which may be stored in a memory or database as part of the service.

In yet another aspect, some issues in meeting a standard may require input from an outside contractor. For example, a new piece of equipment may be needed to keep a network safe. In such instances, the system may provide contact information for vendors that may be able to address the problem. Further the vendors may be listed in an order that reflect past experiences with the vendor from previous entities. The vendors may be stored in a database in the system and entities may be able to score their experiences with the vendor. Finally, vendors may be able to purchase a place in the list of vendors.

The grades of the various standard and the industry may be stored in a memory or in a database in an effort to track the data and have the data be available for further analysis. The data may also include additional information about the test of the standard such as time of the test, the raw score, whether the test results have been scaled, etc. The data may then be analyzed to assist in setting thresholds to meet standards and to assist in showing how meeting standards has changed over time.

The system may also produce additional reports or graphical user interfaces for planning and budgeting purposes. Aspects of a network which may still operate but which may be reaching the end of their useful life may be listed as an expense in the future for a budgeting application.

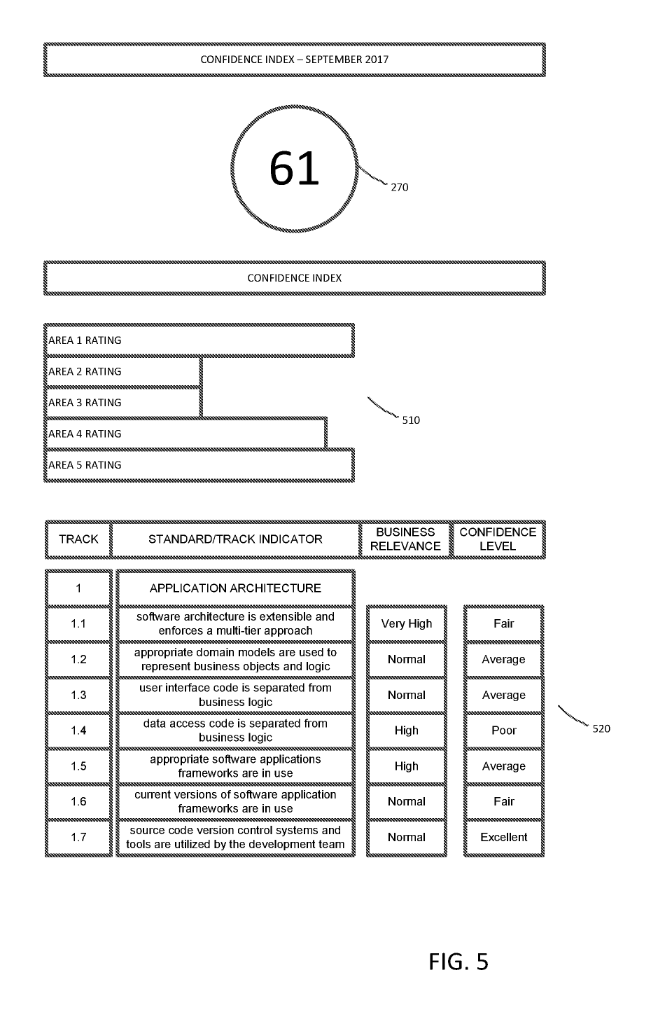

FIG. 5 is an illustration of one embodiment of a summary of an analysis performed by the system 100. An overall rating 270 may be displayed. Bar graphs 510 or any appropriate visual indicator may be used to indicate how the high level aspects of a standard 270 have been met. In addition, a summary of the various elements 520 of a standard and how they have been met may also be part of the report or graphical user interface.

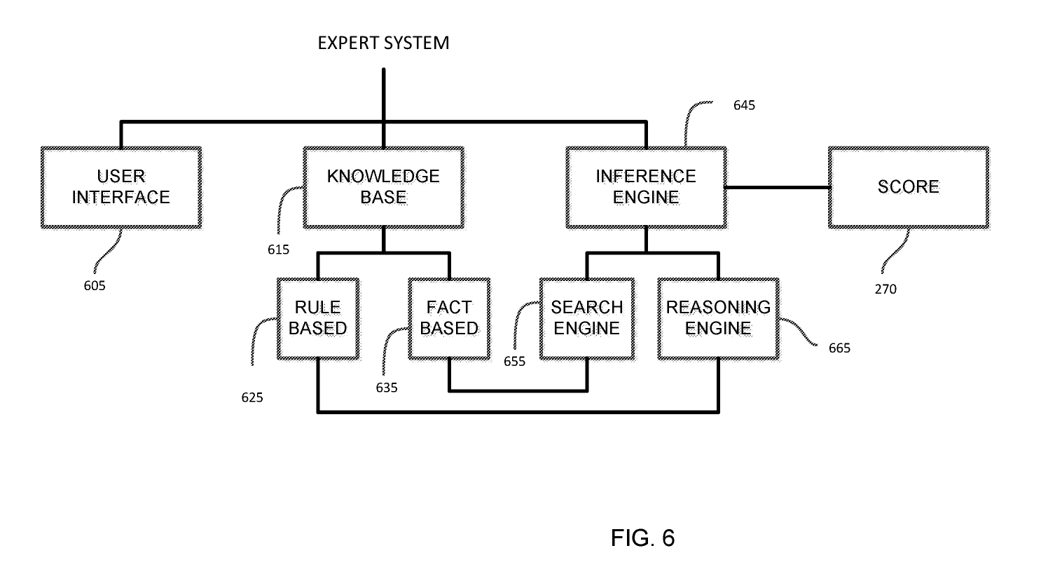

Artificial intelligence or machine learning may be used to refine and improve the system over time as the system may learn from past to better predict the future. The artificial intelligence engine may be used to calculate the score for the various entities. FIG. 6 may illustrate a sample implementation. A user interface 605 may be used to enter the system. A knowledge base 615 may be used to train a model. The knowledge base 615 may be made up of rules 625 and facts 635. The rules 625 may be scoring guides and algorithms. The facts 635 may be gathered facts from observations, audits, self-evaluations or from data gathered through subscriptions. An inference engine 645 may utilize a search engine 655 and a reasoning engine 665 to determine a score 270.

In operation, the scores may be adjusted over time as the rules and facts adjust over time and more knowledge is gained. The knowledge may be utilized by the model as additional data to be reviewed and to improve the model. Further, the rules may also be modified using artificial intelligence to further improve the model. Finally, some facts may become more relevant than others and by subjecting the data to the model, the relative importance of the facts and the rules in creating a score.

The system may address several technical problems with a technical solution. Currently, audits of technology systems have a human element which may be prone to various interpretations and implementation. For example, a first auditor may believe a technology practice is fine while another auditor may believe a technology practice is problematic. As a result, audits of technology may come to different conclusions, even when looking at the same system. The present system eliminates the issues of interpretation by using hardware physically configured accordingly to preset rules which are consistently applied across industries and entities. The result is a score which may be consistent if the system reviews an entity time after time. As a result, an entity may have a realistic understanding of their technology strengths and weakness along with a plan to address the strengths and weaknesses to be above or below an objective measure established for an industry, similar companies, other competitors, etc.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, Ruby, Ruby on Rails, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 10 and the methods described herein may be configured to assess risk of a computer system in a predictable, repeatable manner such that results or scores may be compared against others and across time. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer system for determining a confidence level for technological operations meeting an objective plurality of standards for an entity comprising:
a processor that executes computer executable instructions;
a memory that stores computer executable instructions;
an input output circuit in communication with the processor;
wherein the computer executable instructions comprise instructions for:
receiving a series of testable, objective standards;
evaluating technological operations of the entity against the testable, objective standards;
determining an individual grade for the entity for each testable, objective standard based on the evaluation; and
in response to the individual grade for the entity for any of the testable, objective standard being below a threshold, creating actionable steps to address the testable, objective standard.

2. The computer system of claim 1, further comprising:
determining an overall grade for the entity based on the individual grades; and
in response to the overall grade for the entity being below a threshold, creating a hierarchical list of actionable steps to address the testable, objective standard.

3. The computer system of claim 1, further comprising
receiving an industry classification for the entity;
determining similar entities based on an algorithm;
comparing the rating for the entity to the determined similar entities;
determining a ranking the entity in view of the determined similar entities; and
if the ranking is below a threshold, creating a list of recommended improvements to move above the threshold.

4. The computer system of claim 1, further comprising periodically executing the algorithm to update the grade for the entity.

5. The computer system of claim 1, further comprising estimating costs of the recommendations.

6. The computer system of claim 1, further comprising recommending vendors.

7. The computer system of claim 1, further comprising evaluating industry standards and/or regulatory mandates from a group comprising HIPAA, PCI, ISO, FINRA and other disclosure risks.

8. The computer system of claim 1, further comprising evaluating security risks of software used by the entity.

9. The computer system of claim 1, further comprising evaluating security risks related to undesired disclosure of personal identifiable information held by the entity.

10. The computer system of claim 1, further comprising evaluating security risks related to keyman employees.

11. The computer system of claim 1, further comprising evaluating computer executable instructions that are stored in a code vault/data room.

12. The computer system of claim 1, further comprising evaluating computer executable instructions in a real time basis and displaying ratings in real time.

13. The computer system of claim 1, wherein the standards are used consistently across a plurality of entities.

14. The computer system of claim 1, wherein the entity industry and rating are stored in a memory.

15. The computer system of claim 1, wherein the entity industry and ratings are stored in a database.

16. The computer system of claim 1, wherein the entity updates its ratings or score periodically.

17. The computer system of claim 1, wherein the entity rates and scores more than one sub-entity, and measures those ratings and scores individually and in aggregate across all sub-entities.

18. The computer system of claim 1, wherein the technological operations of the entity comprise elements and the elements are analyzed using machine learning to determine weights to be applied to the elements to address the testable, objective standards.

19. The computer system of claim 1, wherein individual grades for the entity for each testable, objective standard are adjusted over time based on a machine learning algorithm using past experiences for similar entities to adjust the grade.

20. The computer system of claim 1, wherein the threshold for the entity is adjusted over time based on a machine learning algorithm that analyzes past evaluated entities to determine an updated threshold.
